(19) United States
(12) Patent Application Publication
(10) Pub. No.: US 2026/0267422 A1
(43) Pub. Date: Sep. 10, 2026

(54) SYSTEM FOR PREVENTING SIMULTANEOUS ACTIVATION IN A KEYBOARD KEY

(71) Applicant: VeriFone, Inc., Wilmington, DE (US)

(72) Inventor: Richard Alexander Pawlak, Leeds (GB)

(73) Assignee: VeriFone, Inc., Wilmington, DE (US)

(21) Appl. No.: 19/165,443

(22) PCT Filed: Mar. 15, 2024
(86) PCT No.: PCT/US2024/020121

§ 371 Date: Sep. 15, 2025

Related U.S. Application Data
(60) Provisional application No. 63/490,557, filed on Mar. 16, 2023.

(51) Int. Cl. G06F 3/02; G06F 3/023; H01H 13/72

(52) U.S. Cl. CPC G06F 3/0202; G06F 3/023; H01H 13/72

(57) ABSTRACT

A system for preventing simultaneous activation in a keyboard key having at least two switch activating buttons located under a keycap is provided. The system includes an activation prevention member having a first perimeter area and a first aperture configured to receive a first switch activating button therein. The first perimeter area is located such that depression of the keycap during use causes a surface of the keycap to contact the first perimeter area to prevent the first switch activating button from being fully depressed. The system further includes an activation enhancement member having a second perimeter area and a second aperture configured to receive a post extending from the keycap. The thickness of the second perimeter area causes the activation enhancement member to contact a second switch activating button prior to the surface of the keycap when the keycap is depressed.

### CROSS-REFERENCE TO RELATED APPLICATIONS

This application claims priority to U.S. Provisional Patent Application No. 63/490,557, filed Mar. 16, 2023, and entitled “System for Preventing Simultaneous Activation in a Keyboard Key,” the entirety of which is incorporated herein by reference.

### FIELD OF THE DISCLOSURE

The present disclosure is generally directed to systems and methods for preventing simultaneous activation in a keyboard key having at least two switch activating buttons located under a keycap. The present disclosure is also directed to a method for retrofitting a keyboard key having at least two activating buttons located under a keycap to prevent simultaneous activation of the at least two switches based on a depression of the keycap during use.

### BACKGROUND

The keys on a keyboard, such as a keyboard used on a retail point of service (POS) device), often include a keycap that operates a switch located beneath the keycap when the keycap is depressed by a user. When the user presses a keycap, the keycap engages the switch, which in turn outputs a unique keycode associated with that key. Some keyboards include double keycaps that are configured to operate two separate switches located under the keycap for commonly used keys. The double keycap operates two separate switches with two different assigned keycodes, both of which are translated to display the value of the key on the console display. Such double keycaps can result in erroneously outputting both keycodes based on a single press of the keycap. For example, in a retail POS device, the “00” key, which is frequently utilized, may include a double keycap. The cashier may attempt to input a value of $100 using the “00” key. However, the keyboard may output a value of $10,000 based on a single depression of the “00” key. This can result in customer frustration and/or costly financial errors.

### SUMMARY OF THE DISCLOSURE

The present disclosure is generally directed to a system for preventing simultaneous activation in a keyboard key having at least two switch activating buttons located under a keycap. The system advantageously avoids erroneous inputs that can result from keyboard keys having multiple switch activating buttons that provide unique codes related to the same value for the key. The system of the present disclosure can be retrofit to existing keyboards without the need for any specialized tools. The system further provides a cost-effective solution to the erroneous entry problem that does not require any software reprogramming.

According to an aspect of the present disclosure, a system for preventing simultaneous activation in a keyboard key having at least two switch activating buttons located under a keycap is provided. The system includes an activation prevention member having a first perimeter area and a first aperture surrounded by the first perimeter area. The first aperture is configured to receive a first switch activating button therein such that the first perimeter area of the activation prevention member is located around the first switch activating button. The first perimeter area is located in a path of the keycap when the keycap is depressed such that the depression of the keycap during use causes a surface of the keycap to contact the first perimeter area of the activation prevention member to prevent the first switch activating button from being fully depressed. The system further includes an activation enhancement member having a second perimeter area having a thickness and a second aperture surrounded by the second perimeter area. The second aperture is configured to receive a post extending from the keycap such that the second perimeter area is located around the post. The thickness of the second perimeter area causes the activation enhancement member to contact a second switch activating button prior to the surface of the keycap when the keycap is depressed during use to decrease a depression distance required to activate the second switch activating button.

In one aspect, the activation prevention member and the activation enhancement member are formed from a plastic material.

In one aspect, the first aperture is shaped to substantially match at least one portion of an outer perimeter of the first switch activating button.

In one aspect, the first perimeter area has a thickness of about 1.35 millimeters to about 1.95 millimeters.

In one aspect, the second aperture is configured to provide an interference fit with the post.

In one aspect, the second aperture has a diameter of about 5.30 millimeters to about 5.90 millimeters.

In one aspect, the thickness of the second perimeter area is about 0.90 millimeters to about 1.40 millimeters.

In one aspect, the depression distance required to activate the second switch activating button is decreased by about 0.90 millimeters to about 1.40 millimeters.

According to another aspect of the present disclosure, a method for retrofitting a keyboard key having at least two switch activating buttons located under a keycap to prevent simultaneous activation of the at least two switch activating buttons based on a depression of the keycap during use is provided. The method includes: (i) removing the keycap from the keyboard key; (ii) installing an activation prevention member having a first perimeter area and a first aperture surrounded by the first perimeter area on a first switch activating button such that the first perimeter area of the activation prevention member is located around the first switch activating button, wherein the first perimeter area is located in a path of the keycap when the keycap is depressed such that the depression of the keycap during use causes a surface of the keycap to contact the first perimeter area of the activation prevention member to prevent the first switch activating button from being fully depressed; (iii) installing an activation enhancement member having a second perimeter area having a thickness and a second aperture surrounded by the second perimeter area on a post extending from the keycap such that the second perimeter area is located around the post, wherein the thickness of the second perimeter area causes the activation enhancement member to contact a second switch activating button prior to the surface of the keycap when the keycap is depressed during use to decrease a depression distance required to activate the second switch activating button; and (iv) reinstalling the keypad on the keyboard key.

In one aspect, the first switch activating button and the second switch activating button transmit different keycodes when activated.

In one aspect, the first switch activating button and the second switch activating button output the same value to a display terminal when activated.

According to another aspect of the present disclosure, a method of preventing simultaneous activation in a keyboard key having at least two switch activating buttons located under a keycap is provided. The method includes: (i) providing an activation prevention member located in a path of the keycap when the keycap is depressed to prevent a first switch activating button from being fully depressed; and (ii) providing an activation enhancement member that contacts a second switch activating button prior to the surface of the keycap when the keycap is depressed during use to decrease a depression distance required to activate the second switch activating button.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 illustrates an exemplary point-of-sale (POS) device including a keyboard in which the system and methods disclosed herein may be employed, according to aspects of the present disclosure.

FIG. 2 is a partial disassembled view of a keyboard with a keycap removed from an exemplary double key on the keyboard, according to aspects of the present disclosure.

FIG. 3 illustrates an exemplary system for preventing simultaneous activation in a keyboard key having at least two switch activating buttons located under a keycap, according to aspects of the present disclosure.

FIGS. 4A and 4B are top and side views of an exemplary activation prevention member, according to aspects of the present disclosure.

FIGS. 5A and 5B are top and side views of an exemplary activation enhancement member, according to aspects of the present disclosure.

FIG. 6 is a partial disassembled view of a keyboard with a keycap removed from an exemplary double key on the keyboard with the keycap in phantom and the system for preventing simultaneous activation installed, according to aspects of the present disclosure.

FIG. 7 is a flowchart for an exemplary method for retrofitting a keyboard key having at least two switch activating buttons located under a keycap to prevent simultaneous activation of the at least two switch activating buttons based on a depression of the keycap during use, according to aspects of the present disclosure.

FIG. 8 is a flowchart for an exemplary method of preventing simultaneous activation in a keyboard key having at least two switch activating buttons located under a keycap, according to aspects of the present disclosure.

### DETAILED DESCRIPTION OF EMBODIMENTS

One aspect of the present disclosure relates to a system for preventing simultaneous activation in a keyboard key having at least two switch activating buttons located under a keycap is provided. The system includes an activation prevention member having a first perimeter area and a first aperture surrounded by the first perimeter area. The first aperture is configured to receive a first switch activating button therein such that the first perimeter area of the activation prevention member is located around the first switch activating button. The first perimeter area is located in a path of the keycap when the keycap is depressed such that the depression of the keycap during use causes a surface of the keycap to contact the first perimeter area of the activation prevention member to prevent the first switch activating button from being fully depressed. The system further includes an activation enhancement member having a second perimeter area having a thickness and a second aperture surrounded by the second perimeter area. The second aperture is configured to receive a post extending from the keycap such that the second perimeter area is located around the post. The thickness of the second perimeter area causes the activation enhancement member to contact a second switch activating button prior to the surface of the keycap when the keycap is depressed during use to decrease a depression distance required to activate the second switch activating button.

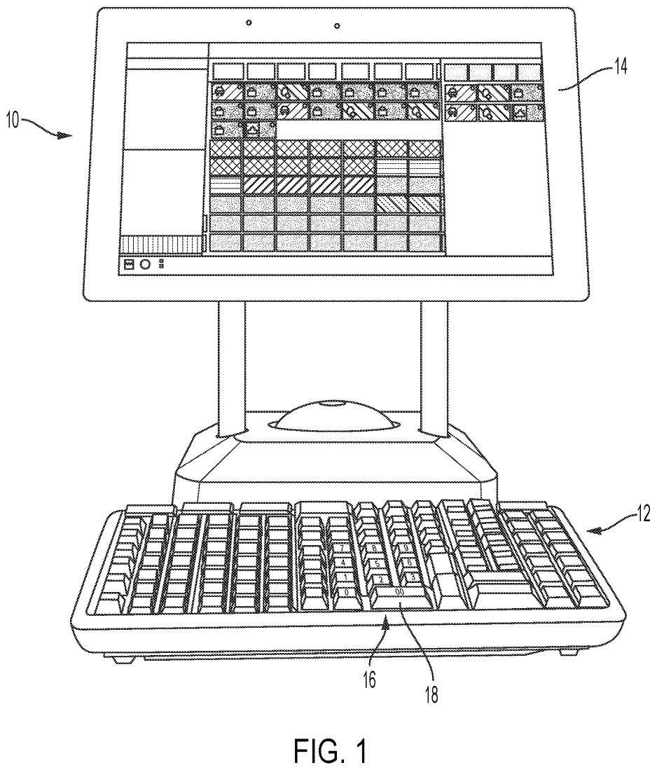

FIG. 1 illustrates an exemplary point-of-sale (POS) device 10 including a keyboard 12 in which the system and methods disclosed herein may be employed. The POS device 10 further includes a display terminal 14 that displays, for example, information input and transmitted from the keyboard 12 based on keystrokes thereon. For example, POS device 10 may be employed in a retail environment, such as a convenience store or gas station. Although POS device 10 having keyboard 12 is illustrated and described, it is to be understood that the system and methods of the present disclosure can be used with other types of devices that employ a keyboard to input and display information.

Referring again to FIG. 1, in this example, the keyboard 12 includes a plurality of keys that activate switches or buttons located under the keys to electronically transmit information to the display terminal 14 in accordance with methods known in the art. The keyboard 12 includes double key 16 having a value of “00” for input to the display terminal 14, although the keyboard 12 may include any number of double keys. Double key 16 has a larger keycap 18 than most of the keys located on the keyboard 12. For example, double keys, such as the double key 16, may be employed for commonly used keys to provide greater visibility and accessibility.

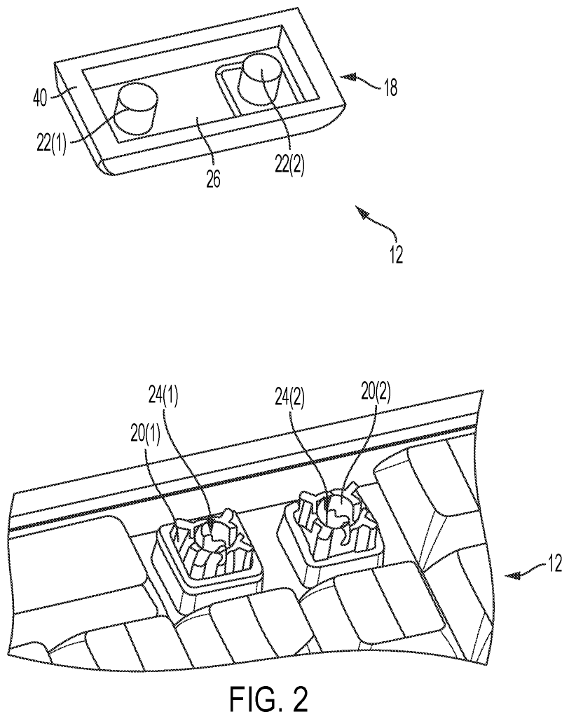

FIG. 2 illustrates a partial view of the keyboard 12 with the keycap 18 removed from the double key 16. The double key 16 in this example includes first and second switch activating buttons 20(1) and 20(2) located on the keyboard 12. First and second switch activating buttons 20(1) and 20(2) are located under, and are activated by, the keycap 18 during use of the keyboard 12. The first and second switch activating buttons 20(1) and 20(2) configured to be depressed by operation of the keycap 18 to provide activation. The first and second switch activating buttons 20(1) and 20(2) are each associated with a unique keycode that is transmitted to the display terminal 14 to display the value associated with the double key 16. For example, the first switch activating button 20(1) may output a unique keycode “31”, while the second switch activating button 20(2) may output a unique key code “159”. Both the first and second switch activating buttons 20(1) and 20(2) when depressed individually, with the keycap 18 removed, display the same value for the double key 16 on the display terminal 14, e.g., “00”.

In this example, the keycap 18 includes posts 22(1) and 22(2) that correspond with recesses 24(1) and 24(2) in the first and second switch activating buttons 20(1) and 20(2), respectively. During standard operation, when the keycap 18 is depressed by the user, the posts 22(1) and 22(2) enter the recesses 24(1) and 24(2) until a surface 26 of the keycap 18 comes into contact with the first and second switch activating buttons 20(1) and 20(2). The force applied by the surface 26 of the keycap 18 depresses the first and second switch activating buttons 20(1) and 20(2) resulting in activation to transmit the value of the double key 16 to the display terminal, for example. In some instances, a single hit to the double key 16 can result in both of the unique codes associated with the first and second switch activating buttons 20(1) and 20(2) being transmitted to the display terminal 14. For example, a cashier attempting to display $100 using the “00” value of the double key 16 may erroneously enter $10,000 when both codes are transmitted to the display terminal 14 based on a single press of the double key 16. The present disclosure eliminates such errors.

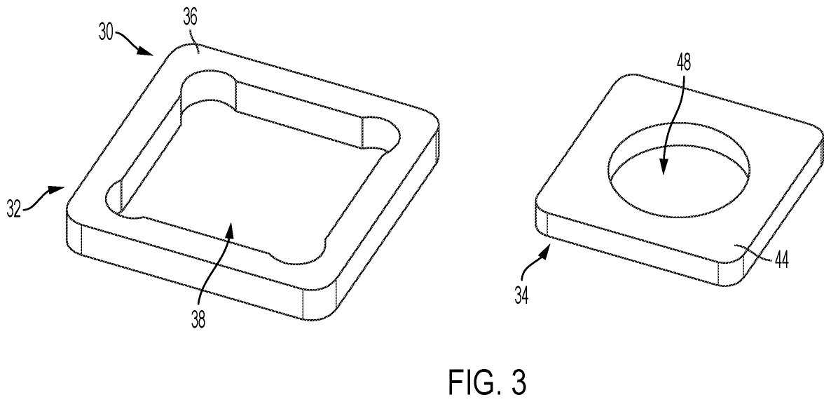

FIG. 3 illustrates an exemplary system 30 that may be employed in the keyboard 12 to prevent simultaneous activation of the first and second switch activating buttons 20(1) and 20(2) resulting in the display of an erroneous value on the display terminal 14, for example. The system 30 includes an activation prevention member 32 and an activation enhancement member 34, although the system 30 may in other examples include other types and/or numbers of members or elements in other combinations to prevent simultaneous activation of the first and second switch activating buttons 20(1) and 20(2). The activation prevention member 32 and the activation enhancement member 34 may be formed of a plastic material, by way of example. The system 30 advantageously provides a solution that prevents unintended key activation from linked keys. The system 30 can be supplied and fitted by the end user to retrofit existing keyboards with no special tools required. Further, system 30 provides a cost-effective solution in comparison to alternate solutions, such as reprogramming the software of the device, such as POS device 10, by way of example.

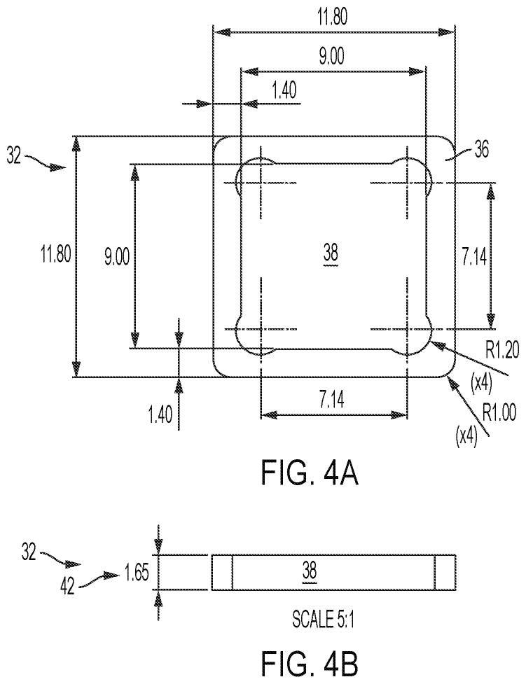

FIGS. 4A and 4B are top and side views, respectively, of the activation prevention member 32 of the system 30 shown in FIG. 3. The dimensions illustrated in FIGS. 4A and 4B are exemplary and other configurations of the activation prevention member 32 with other dimensions are contemplated. In this example, the activation prevention member 32 includes a perimeter area 36 and an aperture 38 surrounded by the perimeter area 36.

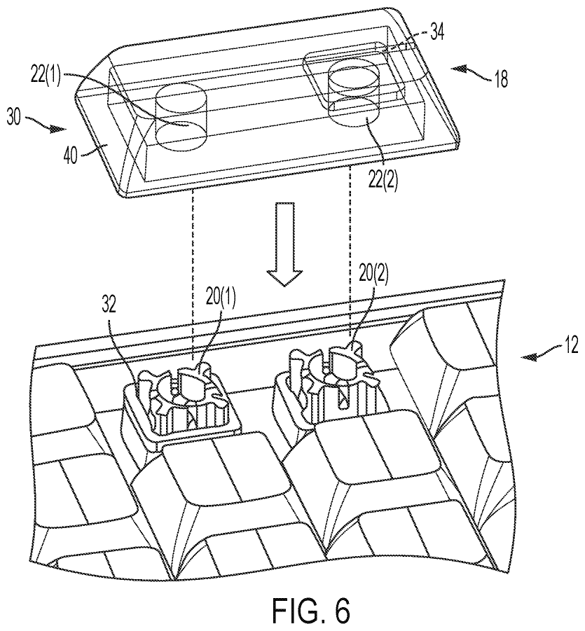

Referring now to FIGS. 4A and 6, the aperture 38 of the activation prevention member 32 is configured to receive the first switch activating button 20(1) therein. As shown in FIG. 6, the perimeter area 36 of the activation prevention member 32 is located around the first switch activating button 20(1) and the first switching button 20(1) extends through the aperture 38. In some examples, the aperture 38 of the activation prevention member 32 is shaped to match at least one portion of an outer perimeter of the first switch activating button 20(1). In this example, the aperture 38 of the activation prevention member 32 includes corner areas that match the shape of the outer perimeter of the first switch activating button 20(1), as shown in FIG. 6.

Referring now more specifically to FIG. 6, when installed, the perimeter area 36 of the activation prevention member 32 is located in a path of the keycap 18 when the keycap 18 is depressed by a user. The depression of the keycap 18 during use causes an edge 40 of the keycap 18 to contact the perimeter area 36 of the activation prevention member 32. The contact between the perimeter area 36 and the edge 40 prevents the surface 26 of the keycap from contacting the first switch activating button 20(1) and fully depressing the first switch activating button 20(1) to transmit a code to the display terminal 14. Thus, there is no output from the first switch activating button 20(1) to the display terminal 14. In one example, the perimeter area 36 of the activation prevention member 32 has a thickness 42 of about 1.35 millimeters to about 1.95 millimeters.

Although the use of the activation prevention member 32 is described below in conjunction with the activation enhancement member 34 on the double key 16, it is to be understood that the activation prevention member 32 could be utilized alone to disable a single key on the keyboard 12 in other examples.

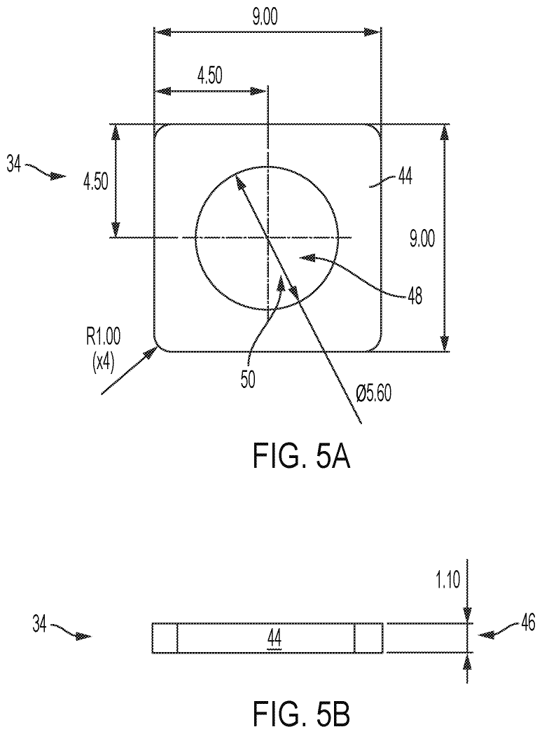

FIGS. 5A and 5B are top and side views, respectively, of the activation enhancement member 34 of the system 30 shown in FIG. 3. The dimensions illustrated in FIGS. 5A and 5B are exemplary and other configurations of the activation enhancement member 34 with other dimensions are contemplated. In this example, the activation enhancement member 34 includes a perimeter area 44 having a thickness 46 and an aperture 48 surrounded by the perimeter area 44. Activation enhancement member 34 can be utilized along with the activation prevention member 32 as described below to provide earlier activation of the second switch activation button 20(2) when the keycap 18 is depressed and to reduce the minor tilt caused by activation prevention member 32 when the keycap 18 is pressed.

Referring now to FIGS. 5A and 6, the aperture 48 of the activation enhancement member 34 is configured to receive post 22(2), which extends from the keycap 18. Thus, the activation enhancement member 34 can be installed on the post 22(2) of the keycap 18 with the perimeter area 44 of the activation enhancement member 34 located around the post 22(2), as shown in FIG. 6. In one example, the aperture 48 is sized to provide an interference fit over the post 22(2) for ease of installation. In one example, the aperture 48 of the activation enhancement member 34 has a diameter 50 of about 5.30 millimeters to about 5.90 millimeters, although other dimensions may be employed.

Referring now more specifically to FIG. 6, when installed, the perimeter area 44 of the activation enhancement member 34 has the thickness 46, which causes the activation enhancement member 34 to contact the second switch activating button 20(2) prior to the surface 26 of the keycap 18 when the keycap 18 is depressed during use. This serves to decrease a depression distance required to activate the second switch activating button 20(2). In one example, the thickness 46 of the perimeter area 44 of the activation enhancement member 34 is about 0.90 millimeters to about 1.40 millimeters, such that the depression distance required to activate the second switch activating button 20(2) is decreased by about 0.90 millimeters to about 1.40 millimeters from standard operation, which requires contact with surface 26 of the keycap 18 to provide activation.

An exemplary operation of the system 30 when installed in the double key 16 of the keyboard 12 will now be described with reference to FIGS. 1-6. During operation, the user depresses the keycap 18 of the double key 16 to transmit the value of the double key 16 to the display terminal 14. When depressed, the surface 26 of the keycap 18 is translated toward the first and second switch activating buttons 20(1) and 20(22). The posts 22(1) and 22(2) enter the corresponding recesses 24(1) and 24(2) in the first and second switch activating buttons 20(1) and 20(2), respectively.

During translation of the keycap 18, the edge 40 of the keycap 18 contacts the activation prevention member 32 on the perimeter area 36 of the activation prevention member 32 located around the first switch activating button 20(1) and prevents the first switch activating button 20(1) from fully depressing. Thus, the first switch activating button 20(1) does not transmit any value to the display terminal 14 based on the keystroke. The contact of the edge 40 of the keycap 18 also provides a slight tilt to the keycap 18. This is remedied by the action of the activation enhancement member 34 as described below.

During translation of the keycap 18, the perimeter area 44 of the activation enhancement member 34 comes into contact with the second switch activating button 20(2) earlier as compared to normal operation, which would require contact with the surface 26 of the keycap 18 to provide activation. Thus, the second switch activating button 20(2) transmits the value of the double key 16 to the display terminal 14 based on the keystroke. The activation enhancement member 34 provides earlier activation of second switch activation button 20(2) when the keycap 18 is depressed and also reduces the minor tilt caused by activation prevention member 32 when the keycap 18 is pressed. The system 30 prevents simultaneous activation of both the first and second switch activating buttons 20(1) and 20(2) to avoid erroneous inputs. The system 30 further adjusts the activation to provide a similar feel when depressing the double key 16 without creating an unnatural tilt.

Another aspect of the present disclosure relates to a method for retrofitting a keyboard key having at least two switch activating buttons located under a keycap to prevent simultaneous activation of the at least two switch activating buttons based on a depression of the keycap during use is provided. The method includes: (i) removing the keycap from the keyboard key; (ii) installing an activation prevention member having a first perimeter area and a first aperture surrounded by the first perimeter area on a first switch activating button such that the first perimeter area of the activation prevention member is located around the first switch activating button, wherein the first perimeter area is located in a path of the keycap when the keycap is depressed such that the depression of the keycap during use causes a surface of the keycap to contact the first perimeter area of the activation prevention member to prevent the first switch activating button from being fully depressed; (iii) installing an activation enhancement member having a second perimeter area having a thickness and a second aperture surrounded by the second perimeter area on a post extending from the keycap such that the second perimeter area is located around the post, wherein the thickness of the second perimeter area causes the activation enhancement member to contact a second switch activating button prior to the surface of the keycap when the keycap is depressed during use to decrease a depression distance required to activate the second switch activating button; and (iv) reinstalling the keypad on the keyboard key.

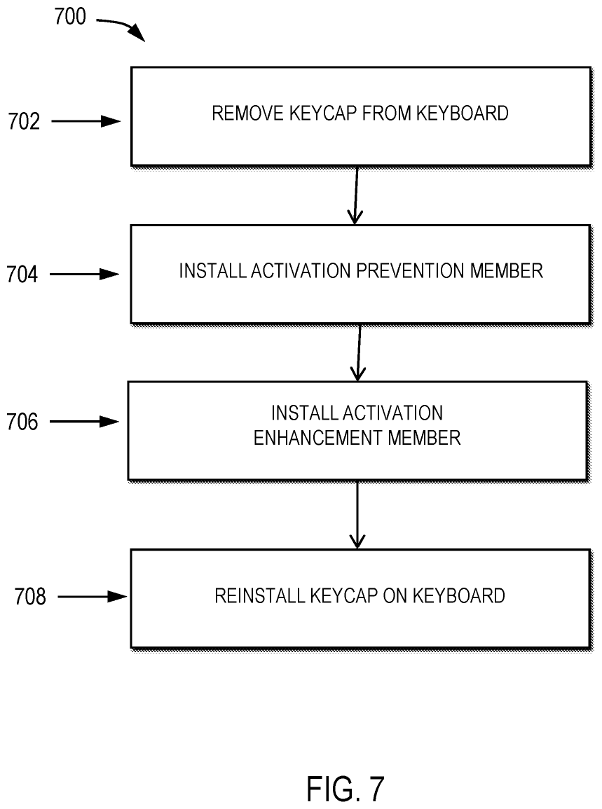

FIG. 7 is an exemplary flowchart of a method 700 of retrofitting the keyboard 12 shown in FIG. 1 with the system 30 of the present disclosure and is described with reference to FIGS. 1-7.

In step 702, the keycap 18 is removed from the double key 16 of the keyboard 12. The keypad generally can be removed using mechanical force. In step 704, the activation prevention member 32 is installed on the first switch activating button 20(1) by placing the aperture 38 of the first switch activating button 20(1). In step 706, the activation enhancement member 34 is installed on the post 22(2) of the keypad 18 by placing the aperture 48 over the post 22(2). In one example, the aperture 48 has an interference fit with the post 22(2) for ease of installation. Next, in step 708, the keypad 18 is reinstalled on the double key 16 of the keyboard 12. The keypad 18 is generally reinstalled by applying a mechanical force.

According to another aspect of the present disclosure, a method of preventing simultaneous activation in a keyboard key having at least two switch activating buttons located under a keycap is provided. The method includes: (i) providing an activation prevention member located in a path of the keycap when the keycap is depressed to prevent a first switch activating button from being fully depressed; and (ii) providing an activation enhancement member that contacts a second switch activating button prior to the surface of the keycap when the keycap is depressed during use to decrease a depression distance required to activate the second switch activating button.

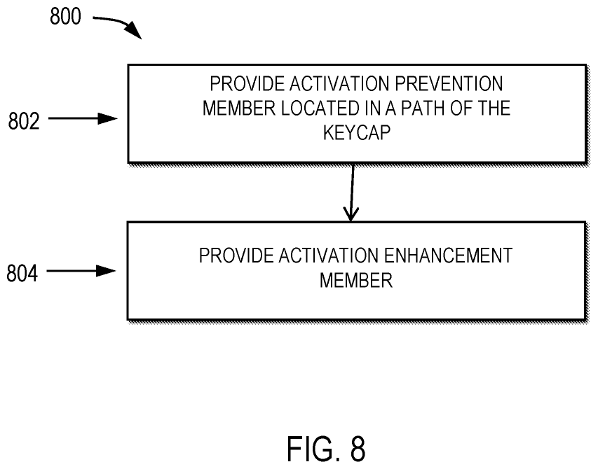

FIG. 8 is an exemplary flowchart of a method 800 of preventing simultaneous activation in a keyboard key having at least two switch activating buttons located under a keycap. The method can be employed in various types of keyboards having different types of switches. In step 802, an activation prevention member is provided located in a path of the keycap when the keycap is depressed to prevent a first switch activating button from being fully depressed. In step 804, an activation enhancement member is provided that contacts a second switch activating button prior to the surface of the keycap when the keycap is depressed during use to decrease a depression distance required to activate the second switch activating button.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system for preventing simultaneous activation in a keyboard key having at least two switch activating buttons located under a keycap, the system comprising:
an activation prevention member having a first perimeter area and a first aperture surrounded by the first perimeter area, the first aperture configured to receive a first switch activating button therein such that the first perimeter area of the activation prevention member is located around the first switch activating button, wherein the first perimeter area is located in a path of the keycap when the keycap is depressed such that the depression of the keycap during use causes a surface of the keycap to contact the first perimeter area of the activation prevention member to prevent the first switch activating button from being fully depressed; and
an activation enhancement member having a second perimeter area having a thickness and a second aperture surrounded by the second perimeter area, the second aperture configured to receive a post extending from the keycap such that the second perimeter area is located around the post, wherein the thickness of the second perimeter area causes the activation enhancement member to contact a second switch activating button prior to the surface of the keycap when the keycap is depressed during use to decrease a depression distance required to activate the second switch activating button.

2. The system of claim 1, wherein the activation prevention member and the activation enhancement member are formed from a plastic material.

3. The system of claim 1, wherein the first aperture is shaped to substantially match at least one portion of an outer perimeter of the first switch activating button.

4. The system of claim 1, wherein the first perimeter area has a thickness of about 1.35 millimeters to about 1.95 millimeters.

5. The system of claim 1, wherein the second aperture is configured to provide an interference fit with the post.

6. The system of claim 1, wherein the second aperture has a diameter of about 5.30 millimeters to about 5.90 millimeters.

7. The system of claim 1, wherein the thickness of the second perimeter area is about 0.90 millimeters to about 1.40 millimeters.

8. The system of claim 7, wherein the depression distance required to activate the second switch activating button is decreased by about 0.90 millimeters to about 1.40 millimeters.

9. A method for retrofitting a keyboard key having at least two switch activating buttons located under a keycap to prevent simultaneous activation of the at least two switch activating buttons based on a depression of the keycap during use, the method comprising:
removing the keycap from the keyboard key;
installing an activation prevention member having a first perimeter area and a first aperture surrounded by the first perimeter area on a first switch activating button such that the first perimeter area of the activation prevention member is located around the first switch activating button, wherein the first perimeter area is located in a path of the keycap when the keycap is depressed such that the depression of the keycap during use causes a surface of the keycap to contact the first perimeter area of the activation prevention member to prevent the first switch activating button from being fully depressed;
installing an activation enhancement member having a second perimeter area having a thickness and a second aperture surrounded by the second perimeter area on a post extending from the keycap such that the second perimeter area is located around the post, wherein the thickness of the second perimeter area causes the activation enhancement member to contact a second switch activating button prior to the surface of the keycap when the keycap is depressed during use to decrease a depression distance required to activate the second switch activating button; and
reinstalling the keypad on the keyboard key.

10. The method of claim 9, wherein the first switch activating button and the second switch activating button transmit different keycodes when activated.

11. The method of claim 9, wherein the first switch activating button and the second switch activating button output the same value to a display terminal when activated.

12. The method of claim 9, wherein the activation prevention member and the activation enhancement member are formed from a plastic material.

13. The method of claim 9, wherein the first aperture is shaped to substantially match at least one portion of an outer perimeter of the first switch activating button.

14. The method of claim 9, wherein the first perimeter area has a thickness of about 1.35 millimeters to about 1.95 millimeters.

15. The method of claim 9, wherein the second aperture is configured to provide an interference fit with the post.

16. The method of claim 9, wherein the second aperture has a diameter of about 5.30 millimeters to about 5.90 millimeters.

17. The method of claim 9, wherein the thickness of the second perimeter area is about 0.90 millimeters to about 1.40 millimeters.

18. The method of claim 17, wherein the depression distance required to activate the second switch activating button is decreased by about 0.90 millimeters to about 1.40 millimeters.

19. A method of preventing simultaneous activation in a keyboard key having at least two switch activating buttons located under a keycap, the method comprising:
providing an activation prevention member located in a path of the keycap when the keycap is depressed to prevent a first switch activating button from being fully depressed; and
providing an activation enhancement member that contacts a second switch activating button prior to the surface of the keycap when the keycap is depressed during use to decrease a depression distance required to activate the second switch activating button.

20. The method of claim 19, wherein the first switch activating button and the second switch activating button transmit different keycodes to provide the same value to a display terminal when activated.
